(19) United States
(12) Patent Application Publication
(10) Pub. No.: US 2007/0068717 A1
(43) Pub. Date: Mar. 29, 2007

(54) HIDDEN FASTENING SYSTEM FOR MOTOR VEHICLE INSTRUMENT PANELS

(76) Inventors: James B. Austin, Denton, TX (US); Robert H. Roose, Decatur, TX (US); Charles W. Rennspies, Southlake, TX (US); Carol P. Bachman, Arlington, TX (US)

Correspondence Address: SIDLEY AUSTIN LLP, 717 NORTH HARWOOD, SUITE 3400, DALLAS, TX, 75201, US

(21) Appl. No.: 11/535,876

(22) Filed: Sep. 27, 2006

Related U.S. Application Data
(60) Provisional application No. 60/720,875, filed on Sep. 27, 2005.

(51) Int. Cl. B62D 25/14; B23P 21/00

(52) U.S. Cl. 180/90; 296/70; 29/469

(57) ABSTRACT

An instrument panel is provided comprising a decorative cover attached to the front side of a backing plate. Hidden fasteners are disposed from the rear of the backing plate. Alignment features on the backing plate and the decorative cover maintain the two components in proper registration while manufacturing the instrument panel. The hidden fasteners align the instrument panel with and fasten it to the surrounding structure, such as the dashboard of a motor vehicle.

Priority for this invention is claimed from U.S. Provisional Application No. 60/720,875, filed Sep. 27, 2005, which application is incorporated herein into entirety.

The present invention relates in general to an improved method and apparatus for attaching an instrument panel to the dashboard of a motor vehicle; and more specifically to an instrument panel, a method for manufacturing the instrument panel, and a method of attaching the instrument panel to the dashboard of a motor vehicle using hidden fasteners.

### BACKGROUND OF THE INVENTION

In some motor vehicles instrument panels are highly customizable. For example, semi truck cabs, including the instrument panel, are often custom made. Similarly, the instrument panel of an aircraft or boat may change depending on the specific instruments used. By varying the size, shape, type, number, and layout of the instruments, indicators, and controls in the instrument panel a purchaser can customize the instrument panel to suit their needs and desires. However, the ability to customize the instrument panel to such a high degree while maintaining a high quality fit and finish can increase the cost of manufacturing the instrument panel.

Various techniques are known for attaching an instrument panel to a dashboard. For example an instrument panel may have through holes for accepting screws, bolts, or other fasteners. Depending on the desired appearance of the dashboard, such fastening methods may be acceptable. Alternatively, hidden fasteners may be used to attach an instrument panel to an underlying dashboard structure so as to provide a smooth, clean appearance. However, using hidden fasteners increases the complexity of manufacturing the instrument panel and can increase the manufacturing cost.

It would therefore be desirable to provide methods and apparatus for efficiently creating a customized instrument panel.

It would also be desirable to provide methods and apparatus for attaching an instrument panel to a dashboard structure using hidden fasteners.

### SUMMARY OF THE INVENTION

The objects and advantages of the present invention are provided by an instrument panel comprising a decorative cover adhered to the front side of a backing plate. Hidden fasteners are disposed from the rear of the backing plate. To simplify manufacturing and ensure high quality, the decorative cover and backing plate are dry assembled for machining. Alignment features on the backing plate and the decorative cover maintain the two components in proper registration while they are machined. The two components are then separated and blind fasteners are attached to the rear of the backing plate. The decorative cover is then permanently adhered to the front of the backing plate. The resulting instrument panel has a decorative cover and blind fasteners protruding from the rear. The fasteners align the instrument panel with and fasten it to the dashboard structure of a motor vehicle.

### BRIEF DESCRIPTION OF THE DRAWINGS

These and other objects and advantages of the present invention will be understood upon consideration of the detailed description taken in conjunction with the accompanying drawings, in which like reference characters refer to like parts, and in which:

FIG. 1 shows an illustrative assembled dashboard and instrument panel; provides some requirements for and materials used in panel manufacturing;

FIG. 2 is a cutaway view of an instrument panel according to the present invention;

FIG. 3 is simplified flow chart of the manufacture of an instrument panel according to the present invention;

FIGS. 4-10 show the steps in manufacturing an instrument panel;

FIGS. 11A and 11B show illustrative alignment features in the decorative panel and backing plate; and

FIG. 12 shows how the ball studs and alignment pins interact with the dashboard support structure and fastening devices.

### DETAILED DESCRIPTION

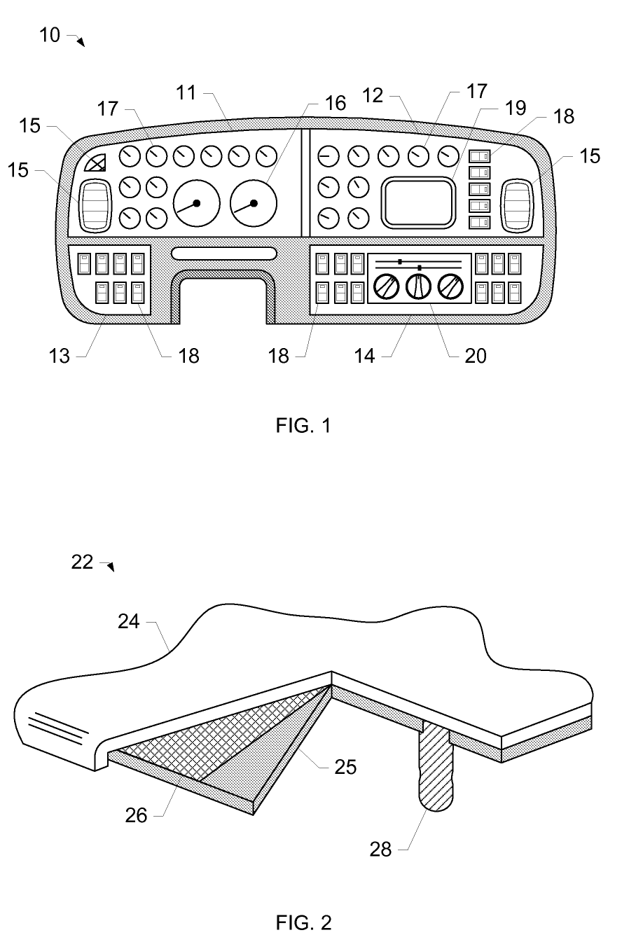

FIG. 1 shows an illustrative instrument panel that might be found in a customized semi truck and which is manufactured in accordance with the principles of the present invention. Generally, dashboard 10 includes four instrument panels 11-14 on which various gauges, dials, indicators, switches, and other types of displays and controls are arranged. For example, instrument panel 11 includes large instruments 16, which would typically be a tachometer and speedometer, as well as smaller gauges 17, which would typically display other operating conditions of truck systems, such as oil pressure, coolant temperature, and the like. Because there are typically many operating parameters to be monitored, additional smaller gauges 17 are provided on instrument panel 12. In addition, instrument panel 12 includes switches or buttons 18 for controlling various systems, such as lights, and display panel 19, which may be a navigation unit or a control unit for a stereo system. In FIG. 1, instrument panels 13 and 14 include additional switches 18, and HVAC controls 20. The specific layout of the instruments, gauges, displays, switches, and controls in FIG. 1, as well as the shape, size, and appearance of these devices is for illustrative purposes, and one skilled in the art would understand that the number and placement of these devices in the instrument panel may be varied.

FIG. 2 shows a cutaway view of an instrument panel in accordance with the principles of the present invention. Instrument panel 22 includes decorative cover 24 attached to backing panel 25. Decorative cover 24 is the visible portion of the instrument panel and may have the appearance of wood grain, brushed metal, leather, or other material, so as to enhance the aesthetic look of the dashboard. Backing plate 25 provides strength and rigidity to instrument panel 22. As shown in FIG. 2, decorative cover 24 may curve over the edge of backing plate 25. It may be also be trimmed flush or extend beyond the edge of backing plate 25 if desired.

Preferably decorative cover 24 is made of plastic, but which may be made of other materials such as metal. Preferably backing plate 25 is made of a metal plate, such as an aluminum or steel plate, so as to be sufficiently strong, rigid, and durable to support all of the devices mounted on or in the instrument panel. Decorative cover 24 is attached to backing plate 25 using adhesive 26. Alignment and/or fastening devices such as ball stud 28 protrude from the rear of backing plate 25. Ball stud 28 mates with alignment holes and fastening devices in the surrounding dashboard structure so as to retain instrument panel 22 in the dashboard. A typical instrument panel will include multiple balls studs, or other fastening device, as well as alignment devices, such as alignment pins. Other fastening and/or alignment devices may be used, including, without limitation, clips, screws, rivet nuts, and molded features.

To save on manufacturing costs while maintaining the fit and finish of the instrument panel it is desirable to machine the decorative cover and backing plate together. This could be done by adhering the decorative cover to the backing plate and then machining them at the same time. However, for instrument panel 22 to have a fastener-free appearance, it is necessary to adhere decorative cover 24 to backing plate 25 after the alignment and fastening devices, e.g., ball studs 28, are installed in backing plate 25. Yet, the presence of ball stud 28 protruding from backing plate 25 may interfere with machining decorative cover 24 and backing plate 25.

In accordance with the principles of the present invention, decorative cover 24 is temporarily clamped or otherwise attached to backing plate 25 while they are being machined to accept the dials, gauges, switches, and the like, which are to be mounted in the instrument panel. After the machining, decorative cover 24 is removed from backing plate 25 and ball studs 28 or other fasteners and alignment devices are installed. Decorative cover 24 is then attached to backing plate 25 using adhesive 26. Mechanical fastening techniques may also be used, provided they do not require through holes in decorative cover 24. Alignment features in decorative cover 24 and backing plate 25 ensure consistent alignment and registration of the two components during the process of manufacturing the instrument panel.

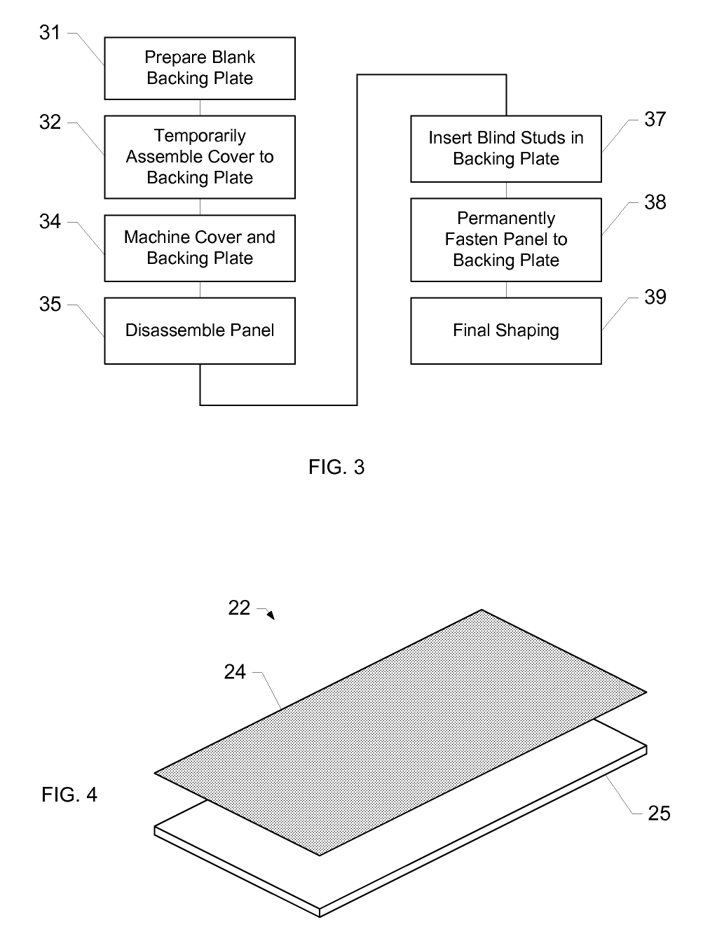

The process of making instrument panel 22 is described in more detail with reference to the flowchart of FIG. 3 in conjunction with FIGS. 4-10. First, at step 31, backing plate 25 is prepared. This may include cutting backing plate 25 to rough dimensions, as well as machining holes to accept ball studs 28, alignment features to register decorative cover 24 with backing plate 25, and non-customizable elements of the instrument panel. For example, the size, shape, and location of openings for air conditioning vents 15, or the overall shape of instrument panel 22 are unlikely to be customizable and may, therefore, be machined when preparing a blank instrument panel.

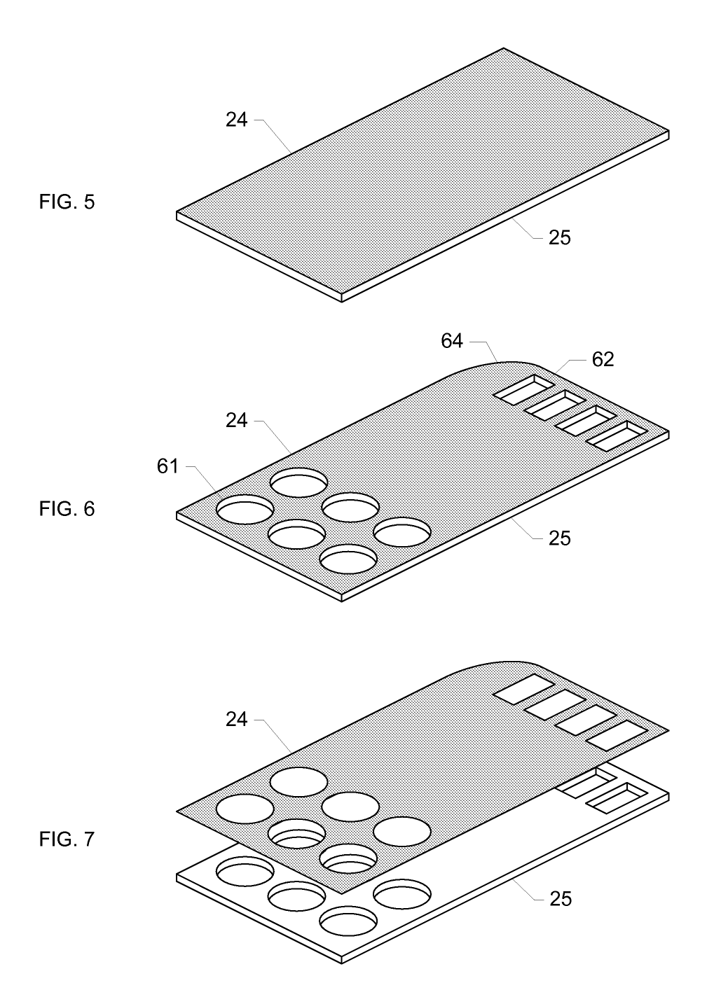

At step 32, decorative cover 24 and backing plate 25 are “dry assembled” to form instrument panel 22. That is, the two pieces are assembled in a non-permanent manner. For example clamps or jigs may be used to hold decorative cover 24 and backing plate 25 together. This is shown in FIGS. 4 and 5, wherein decorative cover 24 is disposed on backing plate 25.

Because hidden fasteners are used to attach the instrument panel to the dashboard, there are no fastener through holes in the panel. This makes it difficult to keep the metal backing plate and plastic panel aligned during manufacture, making consistent assembly of the laminate panel difficult. Moreover, decorative cover 24 cannot be permanently attached to backing plate 25 at the outset, because, as discussed below, they need to be separated and then reassembled as the instrument panel is manufactured.

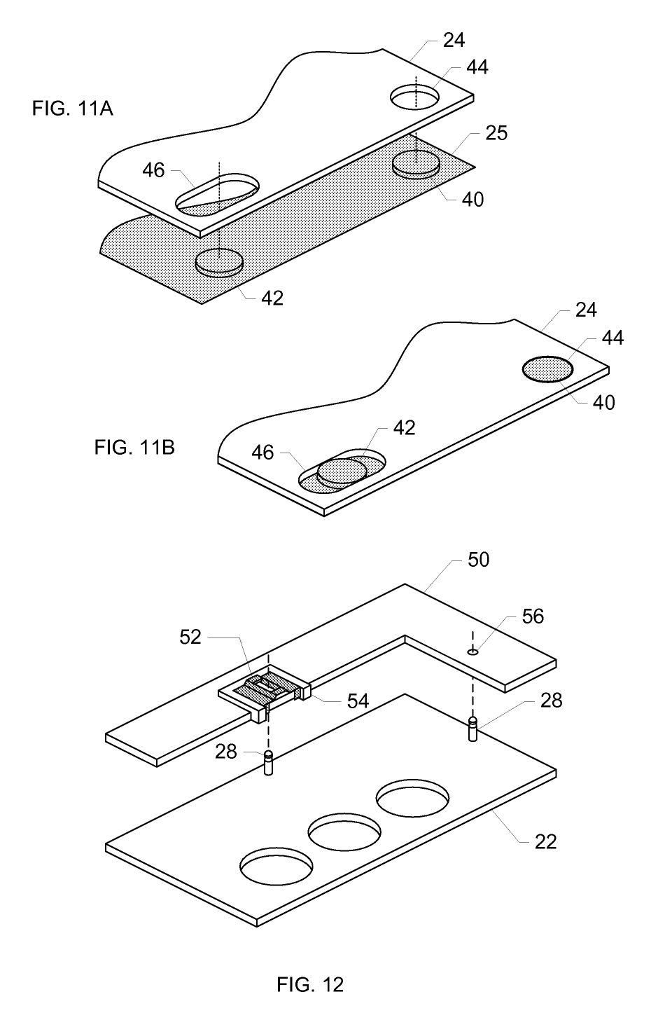

In a preferred embodiment of the invention, decorative cover 24 and backing plate 25 include two-way and four-way locating or alignment features to ensure that they remain in alignment while manufacturing the instrument panel. Decorative cover 24 includes a plurality of alignment features in the form of recesses or protrusions formed on the back thereof. For example, decorative cover 24 may include alignment features in the form of raised dots or circles 40 and 42 formed in the back surface thereof as shown in FIG. 11A. If desired, these alignment features may be formed in waste areas of the instrument panel that will ultimately be removed during the final steps of manufacturing the instrument panel. Backing plate 25 includes corresponding alignment features in the form of circular opening 44 and oblong opening 46.

Whenever decorative cover 24 and backing plate 25 are assembled, the alignment features in decorative cover 24 mate with corresponding alignment features in backing plate 25, as shown in FIG. 11B. Preferably, raised circle 40 fits within circular opening 44 to fairly tight tolerances. The mating of raised circle 40 with circular opening 44 provides four-way lateral registration between the two components. That is, when raised circle 40 is mated with circular opening 44, decorative cover 24 and backing plate 25 cannot move laterally with respect to each other. However, the angle between decorative cover 24 and backing plate 25 is not fixed, because decorative cover 24 can pivot relative to backing plate 25 around the center of raised circle 40. To prevent angular misalignment, additional alignment features are required. Specifically, raised circle 42 is provided on decorative cover 24 so that it mates with oblong opening 46 in backing plate 25 to provide two-way registration between the two parts of instrument panel 22. The combination of multiple alignment features ensures that decorative cover 24 and backing plate 25 remain aligned with each other at each step of manufacturing an instrument panel. Although only two alignment features are shown in FIG. 11A and 11B, it should be understood that additional alignment features may be provided and that alignment features of other sizes and shapes may be used.

As shown at step 34 and FIG. 6, after instrument panel 22 has been dry assembled, appropriate tools are used to form the openings to accept the gauges, switches and other devices to be installed in the instrument panel. Forming the openings in both the plastic panel and metal backing at the same time ensures that the openings are accurately aligned. Illustratively, FIG. 6 shows round openings 61, suitable for the installation of round gauges, and rectangular openings 62, suitable for rectangular switches. The size, shape, and position of the opening in instrument panel 22 are determined by the layout of the instrument panel and the sizes and shapes of the devices to be installed. Additionally, a portion or portions of the perimeter of instrument panel 22 may be cut to shape. For example, instrument panel 22 of FIG. 6 has been machined to provide rounded corner 64. The instrument panel may be formed using manual and/or automated machinery.

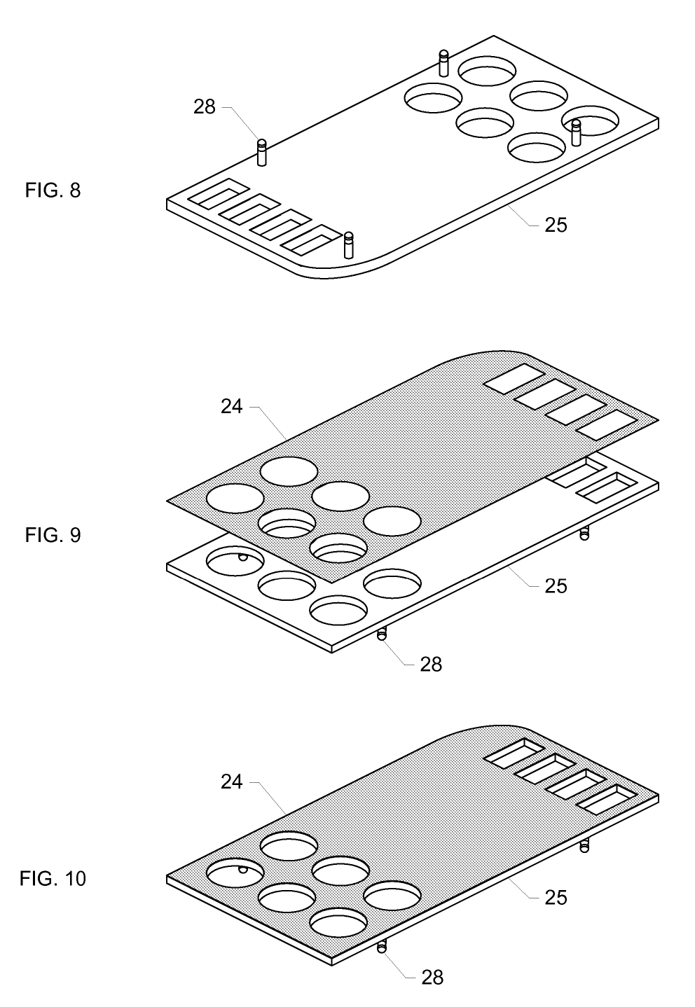

At step 35, which is shown in FIG. 7, instrument panel 22 is disassembled by separating decorative cover 24 from backing plate 25 in preparation for attaching fastening and alignment devices to backing plate 25. At step 37, blind fasteners and alignment devices are attached to backing plate. This is shown in FIG. 8, wherein ball studs 28 are attached to backing plate 25. Preferably, ball studs 28 are swaged in to suitably sized and located holes in backing plate 25. However, ball studs 28 may be attached by welding, riveting, threading, peening, gluing, or any other suitable means.

Next, decorative cover 24 is permanently attached to backing plate 25, as indicated at step 39 and shown in FIG. 9. Preferably, decorative cover 24 is adhered to backing plate 25 using adhesive 26 (See FIG. 2). However, decorative cover 24 may also be attached to backing plate 25 using mechanical fasteners such as screw or bolts that are hidden from view on the rear of decorative cover 24.

Preferably, adhesive 26 is a sheet adhesive with a peel-off backing. One side or surface of the sheet adhesive is adhered to the either decorative cover 24 or backing plate 25 while a peel-off backing is kept on the other side or surface of the sheet adhesive. When decorative cover 24 and backing plate 25 are dry assembled prior to machining, the peel-off backing prevents the two pieces from becoming permanently attached to each other. When the instrument panel is to be assembled after machining, the peel-off backing is removed so that decorative cover 24 and backing plate 25 become permanently bonded together. Alternatively, an adhesive may be applied to the parts just prior to final assembly of the instrument panel.

After decorative cover 24 and backing plate 25 are attached together, additional manufacturing may be performed to finish the instrument panel. For example, the instrument panel may be machined to remove waste portions and/or to establish the final shape of the perimeter. An exemplary finished instrument panel is shown in FIG. 10.

The completed instrument panel is then attached to the dashboard structure. Preferably, the dashboard structure includes features to accept the hidden fasteners and alignment device on the rear of the instrument panel. An example is shown in FIG. 12, wherein instrument panel 22 is attached to dashboard 50 using ball studs 28 and clips 52. Clip 52 is attached to the dashboard structure and is designed to mechanically grip ball stud 28 when it is inserted into clip 52. Molded features 54 help ensure clip 52 is positioned properly. Alignment between instrument panel 22 and dashboard structure 50 is provided by ball stud 28, which fits into locating hole 56. Alternatively, straight or tapered pins may be used instead of ball stud 28 to align and locate instrument panel 22 with dashboard. Similarly, screws, rivet nuts, and other mechanical fasteners may be used instead of ball stud 28 and clip 52.

Thus, an instrument panel and methods of making and using same have been provided. One skilled in the art will appreciate that the present invention can be practiced by other than the described embodiments, which are presented for purposes of illustration and not of limitation, and that the present invention is limited only by the claims which follow.

What is claimed is:

1. An instrument panel having an opening for accepting an instrument, the instrument panel comprising:
a backing plate having an opening for accepting the instrument;
a plurality of hidden fasteners disposed from a rear surface of the backing plate; and
a decorative cover disposed on a front surface of the backing plate, the decorative cover having an opening corresponding to the opening in the backing plate and being disposed on the backing plate so that the opening in the backing plate and the opening in the decorative cover are aligned, and so that the decorative cover substantially covers the front surface of the backing plate.

2. The instrument panel of claim 1, wherein the decorative cover is adhered to the front surface of the backing plate.

3. The instrument panel of claim 2, wherein the decorative cover is adhered to the front surface of the backing plate using a sheet adhesive.

4. The instrument panel of claim 1, wherein the backing plate further comprises at least two alignment features and the decorative cover further comprises at least two alignment features corresponding to the alignment features in the backing plate.

5. The instrument panel of claim 4, wherein the alignment features in the backing plate comprise at least two openings defined therein, and the at least two alignment features in the decorative cover comprise raised portions thereof.

6. The instrument panel of claim 5, wherein the at least two alignment features in the backing plate comprise a circular opening and an oblong opening.

7. The instrument panel of claim 5 wherein the at least two alignment features in the decorative cover comprise at least two raised circular portions.

8. The instrument panel of claim 1, wherein the decorative cover comprises a plastic plate and the backing plate comprises a metal plate.

9. The instrument panel of claim 1, wherein the plurality of hidden fasteners are selected from a group comprising ball studs, threaded studs, screws, bolts, rivet nuts, and clips.

10. The instrument panel of claim 1, wherein the plurality of hidden fasteners are attached to the backing plate by swaging, welding, or threading.

11. A method of manufacturing an instrument panel having a plurality of openings defined therein for the installation of indicators and/or controls, and having a plurality of hidden fasteners for attaching the instrument panel to a supporting structure, the method comprising:
providing a backing plate including at least two locating features formed therein;
providing a cover including at least two locating features corresponding to the locating features in the backing plate;
removably disposing the decorative cover on a front surface of the backing plate such that the locating features on the backing plate and decorative cover mate;
forming a plurality of openings through both the backing plate and the decorative cover corresponding to the openings in the instrument panel for the installation of the indicators and/or controls;
removing the decorative cover from the backing plate;
affixing the plurality of hidden fasteners to a rear surface of the backing plate; and
attaching the cover to the backing plate so that the locating features on the backing plate and cover mate.

12. The method of claim 11 further comprising, forming a portion of a perimeter of the instrument panel while the cover is removably disposed on the backing plate.

13. The method of claim 11 wherein removably disposing the cover on the backing plate comprises clamping the cover to the backing plate.

14. The method of claim 11, wherein affixing the plurality of hidden fasteners to a rear surface of the backing plate comprises swaging each of a plurality of ball studs into one of a plurality of holes formed in the backing plate.

15. The method of claim 11, wherein attaching the cover to the backing plate comprises attaching the cover to the backing plate using an adhesive.

16. The method of claim 15, wherein the adhesive comprises a sheet adhesive.

17. The method of claim 15, further comprising attaching the sheet adhesive to one of the cover and the backing plate such that the sheet adhesive is disposed between the cover and the backing plate when the cover is removably disposed on the backing plate, and the sheet adhesive is prevented from adhering to the other one of the cover and the backing plate.

18. The method of claim 17, wherein the sheet adhesive is prevented from adhering to the other one of the cover and the backing plate by the presence of a peel-off backing.

19. The method of claim 17, wherein attaching the cover to the backing plate comprises removing the peel-off backing and adhering the sheet adhesive to the other one of the cover and the backing plate.

20. The method of claim 11, further comprising removing a portion of the instrument panel so as to remove portions of the cover and backing plate containing the at least two locating features, after attaching the cover to the backing plate.
